(19) United States
(12) Patent Application Publication
(10) Pub. No.: US 2016/0180374 A1
(43) Pub. Date: Jun. 23, 2016

(54) VIEWABLE IMPRESSIONS SYSTEM

(71) Applicant: Yahoo! Inc., Sunnyvale, CA (US)

(72) Inventors: Suleyman Cetintas, Santa Clara, CA (US); Konstantin Shmakov, San Jose, CA (US); Isay Shnayder, San Francisco, CA (US); Lalit Pandey, San Jose, CA (US); Ning Cao, Santa Clara, CA (US)

(73) Assignee: YAHOO! INC., Sunnyvale, IL (US)

(21) Appl. No.: 14/574,033

(22) Filed: Dec. 17, 2014

(51) Int. Cl. G06Q 30/02

(52) U.S. Cl. CPC G06Q 30/0244

(57) ABSTRACT

Described herein are solutions for improving management of viewable impression based display advertising systems. For example, described herein are solutions for improving management of viewable impression based display advertising systems amongst various online marketing channels, such as search engine and guaranteed display advertising (GDA) marketing channels. The solutions can include use of a legacy GDA system and a score (e.g., a ratio) to bridge viewable impression based control and pricing and regular impression based control and pricing.

### BACKGROUND

This application relates to viewable impressions in display advertising. For example, this application relates to integration of a viewable impressions system in a guaranteed display advertising (GDA) system. This application also relates to complete views of audio and/or video (audio/video) advertising, which herein is considered a subset of viewable impressions for simplicity's sake.

Increasingly, advertising is being integrated with online content. Online audiences are demanding free content or at least content delivered at below market prices. Because of this demand, publishers and content networks may be delivering ads with such content to compensate for lost profits. It has also been found that advertising can be acceptable to online audiences if the advertising is useful to audience members. Also, beyond being acceptable, advertising can be sought after by users if it is well targeted. One way to monetize targeting is through viewable impressions. Another way to monetize targeting is through complete views of audio/video advertising.

A viewable impression is a metric of ads that were actually viewable, entirely or in part to a pre-defined extent, when served. Wikipedia, http://en.wikipedia.org/wiki/Viewable_Impression. The definition of a viewable impression may depend on the type of the ad units and the reporting system. Id. For example, a viewable impression for an ad of pre-defined size delivered to a pre-defined spot is logged when the ad content of the impression is loaded, rendered, and at least 50% of the ad surface area is within a visible area of a viewer's browser window on an in focus webpage for at least one second. Id. Another scenario when a viewable impression may be logged includes when a click-through is fully enabled for an ad. Id. For example, the ad content is at least rendered and at least a graphical element of the ad that is clickable is accessible to a viewer.

A complete view is a metric of audio/video ads that were actually provided (such as played), entirely or in part to a pre-defined extent, when served. The definition of a complete view may depend on the type of the ad units and the reporting system. For example, a complete view can be logged when a video ad plays through to the end or thirty seconds, whichever comes first. In another example, a complete view for a video ad can be logged when the video is loaded, rendered, and at least 50% of the video is provided within a visible area of a viewer's browser window on an in focus online property. Another scenario may include an audio only ad that is completely audible when at least 50% of the audio ad is played at a perceivable volume from speakers communicatively coupled to a listener's browser. In other words, a complete view may be considered a category of viewable impressions that specifically applies to audio/video ad content. Because of the difference between an ad with relatively still content and an ad with audio/video content, criteria for logging a viewable impression and a complete view may be different.

Viewable impressions and complete views (hereinafter referred to as viewable impressions for simplicity's sake) were developed to enhance impression metrics measured by ad servers. Historically, ad servers analyzed HTTP requests in a server log and could provide information on events fired by a viewer's browser; but such servers could not measure whether ad content was actually visible to a viewer. Id. To enhance impression metrics, recently, the online ad industry has adopted architectures for viewable impressions.

These architectures may include tags placed on the webpages or in the third-party ad servers that distribute ads on the pages. Id. These tags are placed on a page and when rendered, generate a correlator (i.e., a linear correlation control). Id. The ad space is then identified, an ad request (i.e., an impression) is recorded, and the correlator communicates with the page, the host browser, and the ad space embedded in the webpage content. Id. The correlator can collect information from the viewer's browser, including the viewer's operating system, browser type and version, and a list of other ads that were previously rendered on the page to prevent duplication of ads on the content page. Id. When any portion of the ad (which is definable), on a viewer's in focus webpage, hits the visible area of the browser window, a request is sent to an ad content server to deliver a corresponding advertisement. Id. When the corresponding ad content is loaded and rendered, the loading and rendering is logged. Id. The correlator continues to monitor the ad space on the web page and its relation to the browser window dimensions, scrolling position and web page focus. Id. With the monitoring, it can determine if the viewer has scrolled the ad space in or out of the visible area of the browser window, minimized, tabbed away, or opened another browser or application window bringing the web page monitored out of focus or portion of the browser window with the ad space outside of the monitor screen. Id. When some pre-defined percentage (such as at least 50%) of the ad content on a web page is within the visible area of the viewer's browser window for a pre-defined amount of time (such as one second), a message is sent via correlator and a viewable impression is logged. Id. As it can be imagined, tracking of a complete view can be simpler since an audio/video ad can be distributed through a multimedia player that can have an audio/video content tracking mechanism. Although, for more sophisticated logging of audio/video ad content a correlator can be used as an alternative or in addition to a tracking mechanism of the player. For simplicity's sake, a tracking mechanism of a multimedia player can be considered at least a part of a correlator.

These known techniques for logging viewable impressions are helpful at enhancing impression-based online ad campaigns. However, such techniques have their limitations considering they depend on new systems including at least one correlator. They could also be improved considering the scale of online advertising and the growth of the mobile marketplace for advertising. There is, therefore, a set of engineering problems to be solved in order to provide monetization through viewable impressions that is well adapted to mobile and non-mobile online environments, so that such a monetization technique is enhanced.

Resolution of such engineering problems is pertinent considering the competitive landscape of online advertising. The resolution of these technical issues can benefit advertisers in providing more effective and efficient use of ad impressions and even ad targeting (such as ad retargeting), which may result in a greater number of user interactions with their ads. The novel technologies described herein set out to solve the problem of vast overhead in reconfiguring or building a system that uses a viewable impression as a metric of an ad campaign. The technologies also set out to solve the problem of transitioning legacy systems that exclusively operate on a regular impression basis to systems utilizing the power of viewable impressions, while using a minimal amount of resources for the transition. With this last problem, included is the problem of determining a meaningful relationship between regular impressions (such as non-complete views of an ad with still and/or audio/video content) and actual viewable impressions (such as complete views of an ad with still and/or audio/video content), so that a system can limit the use of a correlator. Today, there is room for improvement for resolving the aforementioned problems in online advertising.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can communicatively couple with an example system that can manage viewable impressions (such as complete views of still and/or audio/video ads).

FIG. 2 illustrates displayed ad items and content items of example screens rendered by client-side applications. Some of the displayed items may be provided through guaranteed display advertising channels that feature management of viewable impressions.

FIGS. 3a and 3b illustrate examples of viewable and non-viewable impressions.

FIG. 4 illustrates a block diagram of example aspects of a system that can manage viewable impressions, such as the system in FIG. 1.

FIG. 5 illustrates example operations performed by a system, such as the systems in FIGS. 1 and 4.

FIGS. 6 and 7 illustrate block diagrams of example devices of a system that can manage viewable impressions, such as the system in FIGS. 1 and 4.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### Overview

Before describing the subject matter more fully with reference to the drawings, this section provides an overview of examples of systems and operations for managing viewable impressions (such as complete views of still and/or audio/video ads). These examples are useful in managing viewable impressions for a legacy online ad system that is based on regular impressions instead of viewable impressions. Regular impressions are online ad impressions that occur on an online property but are not necessarily visible and/or audible to a user.

Display advertisements may be sold on a cost per impression (CPM) basis. In such an environment, not all advertisements are viewable by a user as some ads can be positioned outside an initial viewable area of a page. Such initially non-viewable ads may become viewable by the user scrolling to the non-visible area of the page. As a result, not all ad spots have the same effect on advertising and accordingly have different return on investment. Because of this feature in CPM based ad campaigns, advertisers have begun to shift their budgets to bidding on ads on a cost per viewable impression (vCPM) basis and/or a cost per complete view (CPCV) basis. There are infinite ways to improve forecasting, pricing, and control of online ad campaigns running on a CPM, vCPM, and/or CPCV basis (hereinafter referred to as a CPM and/or vCPM basis for simplicity's sake). Disclosed herein are some novel and non-obvious ways to improve forecasting, pricing, and control of online ad campaigns running on a CPM and/or vCPM basis. These techniques may include a non-parametric model that predicts a probability that an advertisement at an ad spot will be viewed during a user visit based on attributes such as the user's age, sex, and geographic location, webpage content and dimensions, and ad position and dimensions. The model may predict what fraction of impressions at an ad position will be viewable by users. The model may also be combined with impression supply predictions to derive such forecasts. The forecasts then may be used to control distribution of ads and bidding on ads.

In an example, an existing system based on CPM bookings can be integrated with these techniques. The techniques can act as a bridge between CPM based campaigns and vCPM/CPCV based campaigns (hereinafter referred to as vCPM based campaigns for simplicity's sake). This bridge can include information such as what percentage of impressions for a given dimension and/or contract (dimension/contract) will be viewable impressions. This percentage can also be referred to as a viewable impression ratio.

In an example, this information can be used with components of a guaranteed display advertising (GDA) system. Supply forecasting may be included in an impression-based GDA system. The techniques may use existing supply forecasting systems to forecast an amount of impressions for a dimension/contract, and use the viewable impression ratio to forecast the number of viewable impressions for the dimension/contract. For example, directly forecasting the viewable impressions may suffer from seasonality trends and data scarcity since there may not be long-term data available in a new system. This is especially an issue where a campaign has specific target audiences.

Further, allocation enhancement of supply and demand contracts for impressions may also be integrated in the GDA system. For vCPM/CPCV contracts (hereinafter referred to as vCPM contracts for simplicity's sake), enhancement must occur with respect to viewable impressions. Enhancements may use vCPM/CPCV modeling (hereinafter referred to as vCPM modeling for simplicity's sake) to convert a viewable impression goal of a vCPM contract into an impression goal for an impression-based campaign, and seamlessly enhance CPM and vCPM based campaigns in parallel.

Pricing rate cards may also be used in the GDA system. Pricing rate cards may be attributed to viewable impression ratios for different dimensions/contracts using the vCPM modeling. Where the booking part of the GDA system does not include vCPM/CPCV rate cards, viewable impression goals may be converted to regular impression goals using the viewable impression ratio. Direct pricing of viewable impressions may also be used. Yet, since viewable impressions are dependent of regular impressions, such direct pricing is not necessary. For instance, for bookable dimensions for which the viewable impression ratio is relatively low, impression price may be increased since those dimensions require more impressions to reach a certain viewable impression goal. Therefore, the techniques may price viewable impressions using the viewable impression ratio to convert a viewable impression goal into a regular impression goal. For example, the techniques may calculate a floor price according to the ratio, so that the price would reflect how much it would cost to buy certain number of viewable impressions via bids on regular impressions.

Although, it is possible to build an entirely new system to deliver viewable impressions in a GDA system, use of an already existing regular-impression-based GDA system may be more efficient. Also, even if an entirely new system is built for viewable impressions, that system being new may lack historical data to make accurate and stable forecasts. Yet, using an existing and older supply forecasting of a regular-impression-based GDA system should provide more stable and accurate forecasts. Building a new system also includes new complexities that result in risks of bugs, system down times, and therefore possible malformed audience and advertiser experiences. This can lead to decreases in revenue and new business. Since the techniques herein may use mature and proven regular-impression-based GDA systems, it is expected that launches of the techniques and corresponding transitions will not be as costly. Also, these techniques provide an enhancement to a GDA system, which usually is only available with non-guaranteed display advertising (NGD) systems. In other words, a performance based online ad system may be provided through an impression based online ad system, with only minor updates to parts of an online ad delivery system (such as updates to a forecasting aspect of the system).

### DESCRIPTION OF THE DRAWINGS

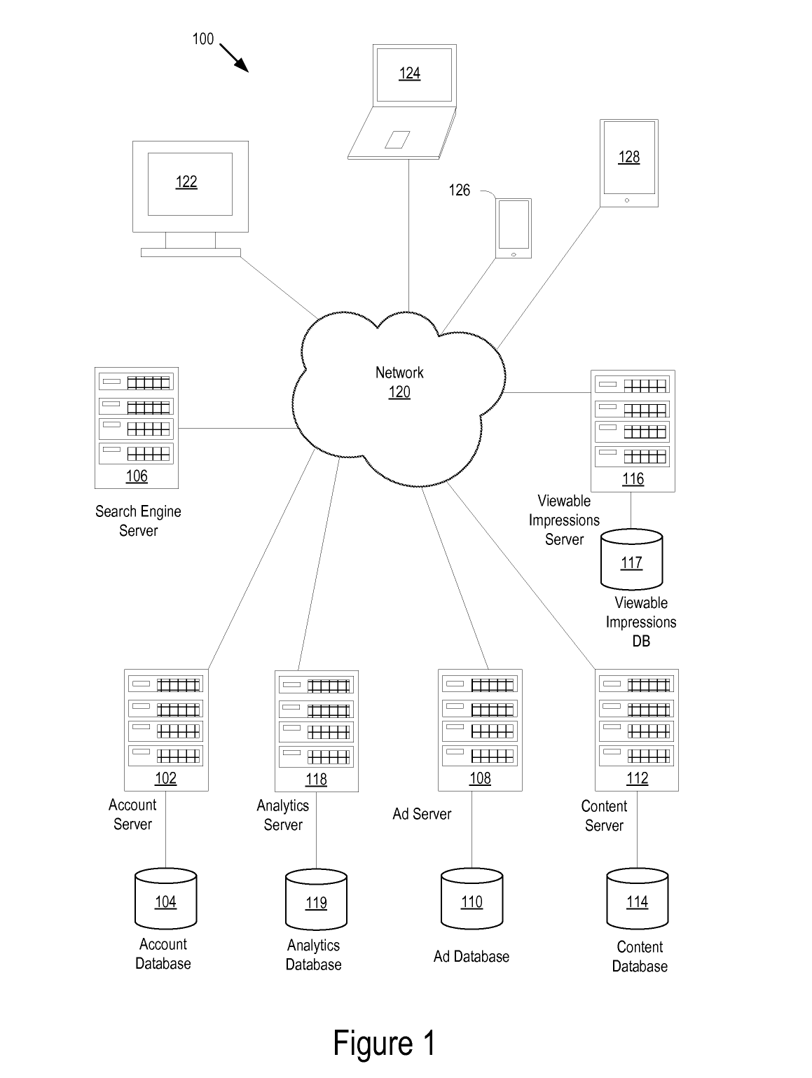

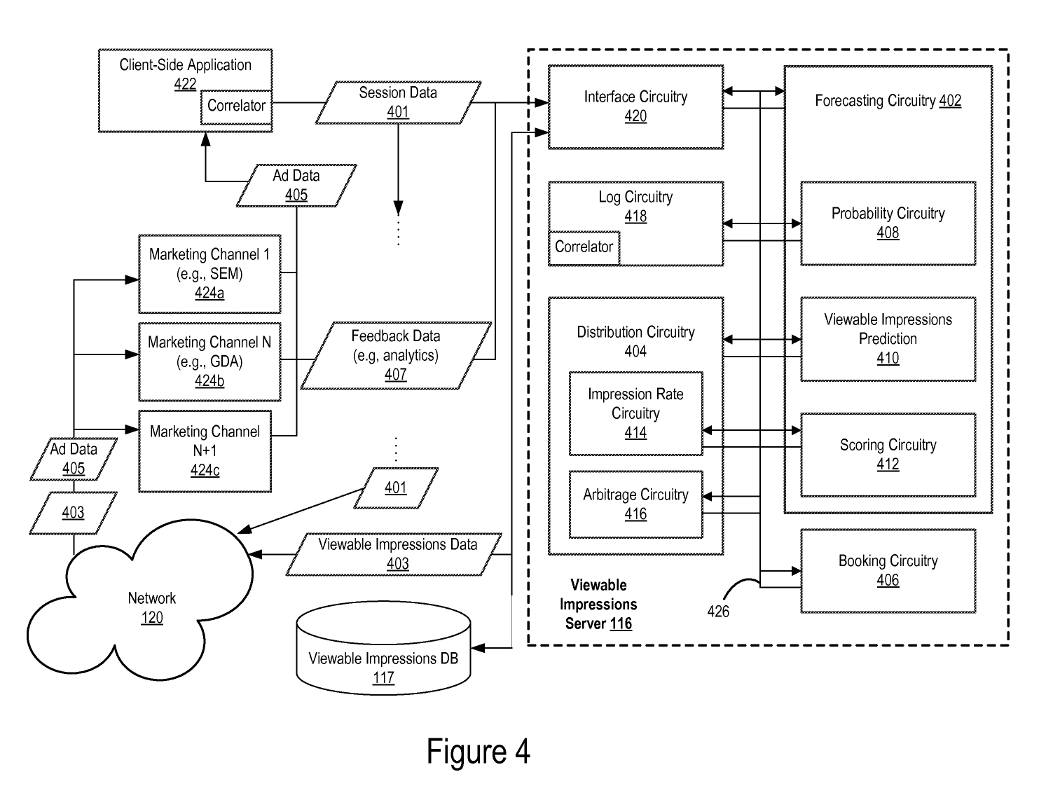

FIG. 1 illustrates a block diagram of an example information system 100 that includes example devices of a network that can communicatively couple with an example system that can manage viewable impressions (such as complete views of still and/or audio/video ads). For example, FIG. 1 illustrates an example system that can manage viewable impressions by providing guaranteed viewable impressions through a legacy impression-based channel, such as a GDA channel (e.g., see marketing channel 424b illustrated in FIG. 4). The information system 100 in the example of FIG. 1 includes an account server 102, an account database 104, a search engine server 106, an ad server 108, an ad database 110, a content database 114, a content server 112, a viewable impressions server 116, a viewable impressions database 117, an analytics server 118, and an analytics database 119. The aforementioned servers and databases can be communicatively coupled over a network 120. The network 120 may be a computer network. The aforementioned servers may each be one or more server computers.

The information system 100 may be accessible over the network 120 by advertiser devices and audience devices, which may be desktop computers (such as device 122), laptop computers (such as device 124), smartphones (such as device 126), and tablet computers (such as device 128). An audience device can be a user device that presents online advertisements, such as a device that presents online advertisements to an audience member. In various examples of such an online information system, users may search for and obtain content from sources over the network 120, such as obtaining content from the search engine server 106, the ad server 108, the ad database 110, the content server 112, and the content database 114. Advertisers may provide advertisements for placement on online properties, such as web pages, and other communications sent over the network to audience devices. The online information system can be deployed and operated by an online services provider, such as Yahoo! Inc.

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content.

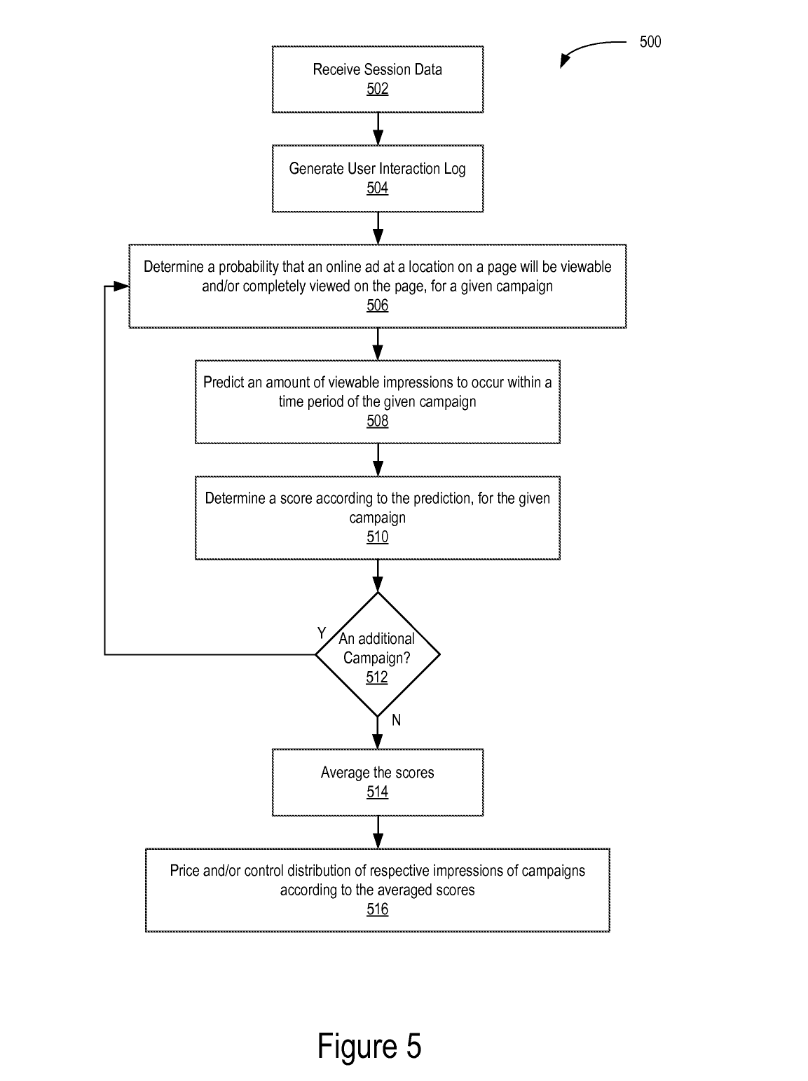

The account information may include ad booking information, and such booking information may be communicated to the viewable impressions server 116 for processing. This booking information can be used as input for determining attributes described in the descriptions of FIGS. 4 and 5. For example, the ad booking information may be used in the determination of the various scores determined by aspects described in FIGS. 4 and 5. Also, at least parts of the booking information can be derived from the outputs of these aspects of FIGS. 4 and 5. For example, parts of the booking information, such as bids on impressions, can be derived from output of the booking circuitry 406 illustrated in FIG. 4.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser. The advertiser front end may be a program, application, or software routine that forms a user interface. In a particular example, the advertiser front end is accessible as a website with electronic properties that an accessing advertiser may view on an advertiser device, such as one of the devices 122-128 when logged on by an advertiser. The advertiser may view and edit account data and advertisement data, such as ad booking data, using the advertiser front end. After editing the advertising data, the account data may then be saved to the account database 104.

The search engine server 106 may be one or more servers. Alternatively, the search engine server 106 may be a computer program, instructions, or software code stored on a computer-readable storage medium that runs on one or more processors of one or more servers. The search engine server 106 may be accessed by audience devices over the network 120. An audience client device may communicate a user query to the search engine server 106. For example, a query entered into a query entry box can be communicated to the search engine server 106. The search engine server 106 locates matching information using a suitable protocol or algorithm and returns information to the audience client device, such as in the form of ads or content.

The search engine server 106 may be designed to help users and potential audience members find information located on the Internet or an intranet. In an example, the search engine server 106 may also provide to the audience client device over the network 120 an electronic property, such as a web page, with content, including search results, information matching the context of a user inquiry, links to other network destinations, or information and files of information of interest to a user operating the audience client device, as well as a stream or web page of content items and advertisement items selected for display to the user. This information provided by the search engine server 106 may be logged, and such logs may be communicated to the analytics server 118 for processing and analysis. Besides this information, any data outputted by processes of the servers of FIG. 1 may also be logged, and such logs can be communicated to the analytics server 118 for further processing and analysis. The data logs and/or the analytics outputted by the server 118 can be input for the various operations and aspects of the forecasting circuitry 402, the distribution circuitry 404, and/or the booking circuitry 406 illustrated in FIG. 4.

The search engine server 106 may enable a device, such as an advertiser client device or an audience client device, to search for files of interest using a search query. Typically, the search engine server 106 may be accessed by a client device (such as the devices 122-128) via servers or directly over the network 120. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The ad server 108 may be one or more servers. Alternatively, the ad server 108 may be a computer program, instructions, and/or software code stored on a computer-readable storage medium that runs on one or more processors of one or more servers. The ad server 108 operates to serve advertisements to audience devices. An advertisement may include text data, graphic data, image data, video data, or audio data. Advertisements may also include data defining advertisement information that may be of interest to a user of an audience device. The advertisements may also include respective audience targeting information and/or ad campaign information. An advertisement may further include data defining links to other online properties reachable through the network 120. The aforementioned audience targeting information and the other data associated an ad may be logged in data logs. These logs, similar to other data logs described herein, can also be communicated to the analytics server 118 for further processing and analysis. The data logs and/or the analytics outputted by the server 118 can be input for the various operations and aspects of the forecasting circuitry 402, the distribution circuitry 404, and/or the booking circuitry 406.

For online service providers, advertisements may be displayed on electronic properties resulting from a user-defined search based, at least in part, upon search terms. Also, advertising may be beneficial and/or relevant to various audiences, which may be grouped by demographic and/or psychographic. A variety of techniques have been developed to determine audience groups and to subsequently target relevant advertising to members of such groups. Group data and individual user's interests and intentions along with targeting data related to campaigns may be may be logged in data logs. As mentioned, one approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases, for example. An identified correlation may be used to target potential purchasers by targeting content or advertisements to particular users. Similarly, the aforementioned profile-type targeting data may be logged in data logs. Yet another approach includes targeting based on content of an electronic property requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data may be logged in data logs.

The ad server 108 includes logic and data operative to format the advertisement data for communication to an audience member device, which may be any of the devices 122-128. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look for advertising items in the stream. The aforementioned advertising data may be logged in data logs.

Further, the ad server 108 is in data communication with the network 120. The ad server 108 communicates ad data and other information to devices over the network 120. This information may include advertisement data communicated to an audience device. This information may also include advertisement data and other information communicated with an advertiser device. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provides the ad items to other network devices, such as the viewable impressions server 116, the analytics server 118, and/or the account server 102. Ad items and ad information, such as pricing, can be used as input for the various operations and aspects of the forecasting circuitry 402, the distribution circuitry 404, and/or the booking circuitry 406.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device. In viewing and editing the advertising data, adjustments can be used as input for the various operations and aspects of the forecasting circuitry 402, the distribution circuitry 404, and/or the booking circuitry 406. The advertiser front end may also provide a graphical user interface for simulating ad campaigns according operations performed by the viewable impressions server 116 and associated circuitry (such as the client-side application circuitry 422).

The content server 112 may access information about content items either from the content database 114 or from another location accessible over the network 120. The content server 112 communicates data defining content items and other information to devices over the network 120. The information about content items may also include content data and other information communicated by a content provider operating a content provider device. A content provider operating a content provider device may access the content server 112 over the network 120 to access information. This access may be for developing content items, editing content items, deleting content items, setting and adjusting bid amounts and other activities, such as associating content items with certain types of ad campaigns. A content provider operating a content provider device may also access the viewable impressions server 116 over the network 120 to access analytics data and controller related data. Such analytics and controller data may help focus developing content items, editing content items, deleting content items, setting and adjusting bid amounts, and activities related to distribution of the content.

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120. In editing the content data, adjustments to controller variables and parameters may be determined and presented upon editing of the content data, so that a publisher can view how changes affect pacing of one or more ad campaigns.

The content provider front end may be a client-side application. A script and/or applet and the script and/or applet may manage the retrieval of campaign data. In an example, this front end may include a graphical display of fields for selecting audience segments, segment combinations, or at least parts of campaigns. Then this front end, via the script and/or applet, can request data related to campaign pacing from the viewable impressions server 116. The information related to campaign pacing can then be displayed, such as displayed according to the script and/or applet.

The content server 112 includes logic and data operative to format content data for communication to the audience device. The content server 112 can provide content items or links to such items to the analytics server 118 or the viewable impressions server 116 to associate with campaign pacing. For example, content items and links may be matched to such data. The matching may be complex and may be based on historical information related to control of campaigns, such as pacing control of campaigns.

The content data may be formatted to a content item that may be included in a stream of content items and advertisement items provided to an audience device. The formatted content items can be specified by appearance, size, shape, text formatting, graphics formatting and included information, which may be standardized to provide a consistent look for content items in the stream. The formatting of content data and other information and data outputted by the content server may be logged in data logs. For example, content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, such as may employ differing architectures or may be compliant or compatible with differing protocols, may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

An advertiser client device, which may be any one of the device 122-128, includes a data processing device that may access the information system 100 over the network 120. The advertiser client device is operative to interact over the network 120 with any of the servers or databases described herein. The advertiser client device may implement a client-side application for viewing electronic properties and submitting user requests. The advertiser client device may communicate data to the information system 100, including data defining electronic properties and other information. The advertiser client device may receive communications from the information system 100, including data defining electronic properties and advertising creatives. The aforementioned interactions and information may be logged in data logs.

In an example, content providers may access the information system 100 with content provider devices that are generally analogous to the advertiser devices in structure and function. The content provider devices provide access to content data in the content database 114, for example.

An audience client device, which may be any of the devices 122-128, includes a data processing device that may access the information system 100 over the network 120. The audience client device is operative to interact over the network 120 with the search engine server 106, the ad server 108, the content server 112, the viewable impressions server 116, and the analytics server 118. The audience client device may implement a client-side application for viewing electronic content and submitting user requests. A user operating the audience client device may enter a search request and communicate the search request to the information system 100. The search request is processed by the search engine and search results are returned to the audience client device. The aforementioned interactions and information may be logged.

In other examples, a user of the audience client device may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device. The aforementioned interactions and information may be logged in data logs and such logs.

An advertiser client device and an audience client device operate as a client device when accessing information on the information system 100. A client device, such as any of the devices 122-128, may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or games. The foregoing is provided to illustrate that claimed subject matter is intended to include a wide range of possible features or capabilities. At least some of the features, capabilities, and interactions with the aforementioned may be logged in data logs.

Also, the disclosed methods and systems may be implemented at least partially in a cloud-computing environment, at least partially in a server, at least partially in a client device, or in a combination thereof.

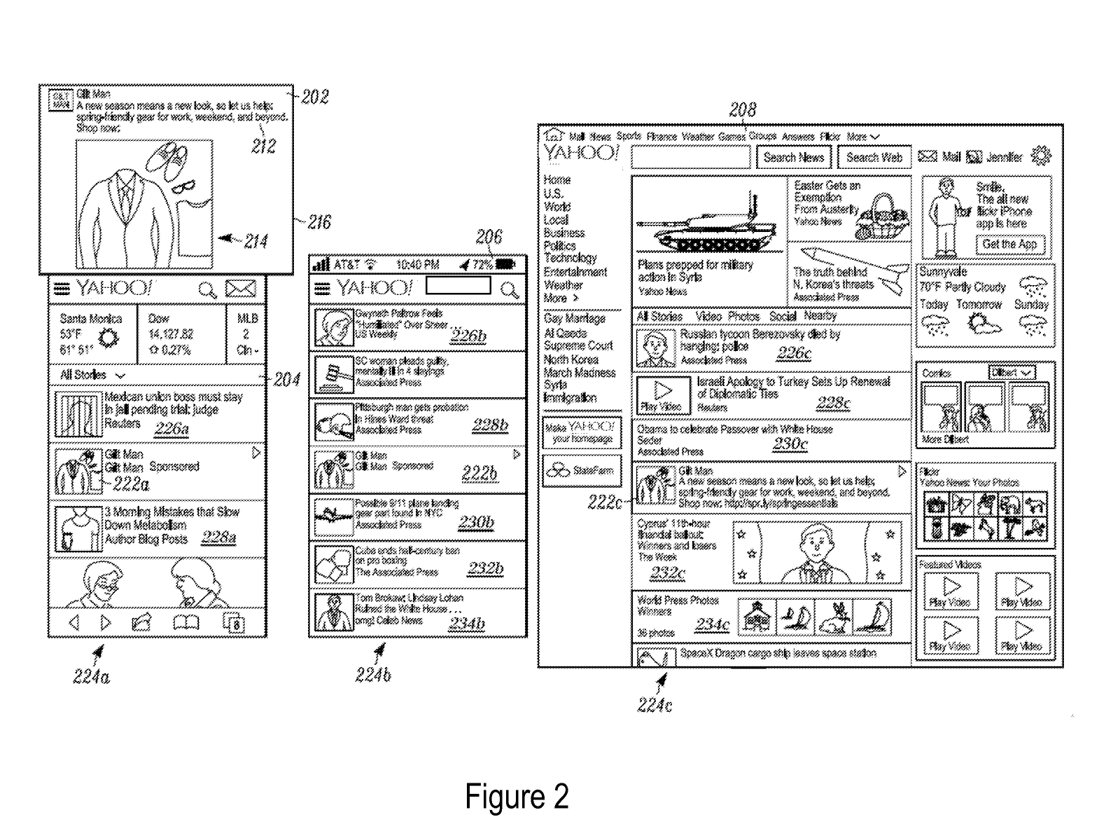

FIG. 2 illustrates displayed ad items and content items of example screens rendered by client-side applications. The content items and ad items displayed may be provided by the search engine server 106, the ad server 108, or the content server 112. User interactions with the ad items and content items can be tracked and logged in data logs, and the logs may be communicated to the analytics server 118 for processing. Once processed into corresponding analytics data, the analytics data can be input for the various operations and aspects of the forecasting circuitry 402, the distribution circuitry 404, and/or the booking circuitry 406, which are illustrated in FIG. 4. Also, session data including indications of the user interactions with the items (such as session data 401) may be directly communicated to the interface circuitry 420 and then identified and logged by the log circuitry 418 illustrated in FIG. 4. The data logs and/or the analytics outputted by the server 118 can be input for the various operations and aspects of the forecasting circuitry 402, the distribution circuitry 404, and/or the booking circuitry 406.

In FIG. 2, a display ad 202 is illustrated as displayed on a variety of displays including a mobile web device display 204, a mobile application display 206 and a personal computer display 208. The mobile web device display 204 may be shown on the display screen of a smart phone, such as the device 126. The mobile application display 206 may be shown on the display screen of a tablet computer, such as the device 128. The personal computer display 208 may be displayed on the display screen of a personal computer (PC), such as the desktop computer 122 or the laptop computer 124.

The display ad 202 is shown in FIG. 2 formatted for display on an audience device but not as part of a stream to illustrate an example of the contents of such a display ad. The display ad 202 includes text 212, graphic images 214 and a defined boundary 216. The display ad 202 can be developed by an advertiser for placement on an electronic property, such as a web page, sent to an audience device operated by a user. The display ad 202 may be placed in a wide variety of locations on the electronic property. The defined boundary 216 and the shape of the display ad can be matched to a space available on an electronic property. If the space available has the wrong shape or size, the display ad 202 may not be useable. Such reformatting may be logged in data logs and such logs may be communicated to the analytics server 118 for processing. The data logs and/or the processed analytics can be input for the various operations and aspects of the forecasting circuitry 402, the distribution circuitry 404, and/or the booking circuitry 406.

In these examples, the display ad is shown as a part of streams 224a, 224b, and 224c. The streams 224a, 224b, and 224c include a sequence of items displayed, one item after another, for example, down an electronic property viewed on the mobile web device display 204, the mobile application display 206 and the personal computer display 208. The streams 224a, 224b, and 224c may include various types of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items can be items published by non-advertisers. However, these content items may include advertising components. Each of the streams 224a, 224b, and 224c may include a number of content items and advertising items.

In an example, the streams 224a, 224b, and 224c may be arranged to appear to the user to be an endless sequence of items, so that as a user, of an audience device on which one of the streams 224a, 224b, or 224c is displayed, scrolls the display, a seemingly endless sequence of items appears in the displayed stream. The scrolling can occur via the scroll bars, for example, or by other known manipulations, such as a user dragging his or her finger downward or upward over a touch screen displaying the streams 224a, 224b, or 224c. To enhance the apparent endless sequence of items so that the items display quicker from manipulations by the user, the items can be cached by a local cache and/or a remote cache associated with the client-side application or the page view. Such interactions may be communicated to the analytics server 118. The corresponding analytics outputted by the server 118 can be input for the various operations and aspects of the forecasting circuitry 402, the distribution circuitry 404, and/or the booking circuitry 406.

The content items positioned in any of streams 224a, 224b, and 224c may include news items, business-related items, sports-related items, etc. Further, in addition to textual or graphical content, the content items of a stream may include other data as well, such as audio and video data or applications. Each content item may include text, graphics, other data, and a link to additional information. Clicking or otherwise selecting the link re-directs the browser on the client device to an electronic property referred to as a landing page that contains the additional information. The clicking or otherwise selecting of the link, the re-direction to the landing page, the landing page, and the additional information, for example, can each be tracked, and then the data associated with the tracking can be logged in data logs, and such logs may be communicated to the analytics server 118 for processing. The data logs and/or the analytics outputted by the server 118 can be input for the various operations and aspects of the forecasting circuitry 402, the distribution circuitry 404, and/or the booking circuitry 406.

Stream ads like the advertising items 222a, 222b, and 222c may be inserted into the stream of content, supplementing the sequence of related items, providing a more seamless experience for end users. Similar to content items, the advertising items may include textual or graphical content as well as other data, such as audio and video data or applications. Each advertising item 222a, 222b, and 222c may include text, graphics, other data, and a link to additional information. Clicking or otherwise selecting the link re-directs the browser on the client device to an electronic property referred to as a landing page. The clicking or otherwise selecting of the link, the re-direction to the landing page, the landing page, and the additional information, for example, can each be tracked, and then the data associated with the tracking can be logged in data logs, and such logs may be communicated to the analytics server 118 for processing. The data logs and/or the analytics outputted by the server 118 can be input for the various operations and aspects of the forecasting circuitry 402, the distribution circuitry 404, and/or the booking circuitry 406.

While the example streams 224a, 224b, and 224c are shown with a single visible advertising item 222a, 222b, and 222c, respectively, a number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms. Also, slotting may be according to campaign control.

The slotting and any other operation associated with campaign control described herein may occur via controller interface circuitry that provides interfacing between a controller and other types of circuits, such as a circuit of any of the servers illustrated in FIG. 1. The controller interface circuitry and the controller may be hosted on the viewable impressions server 116.

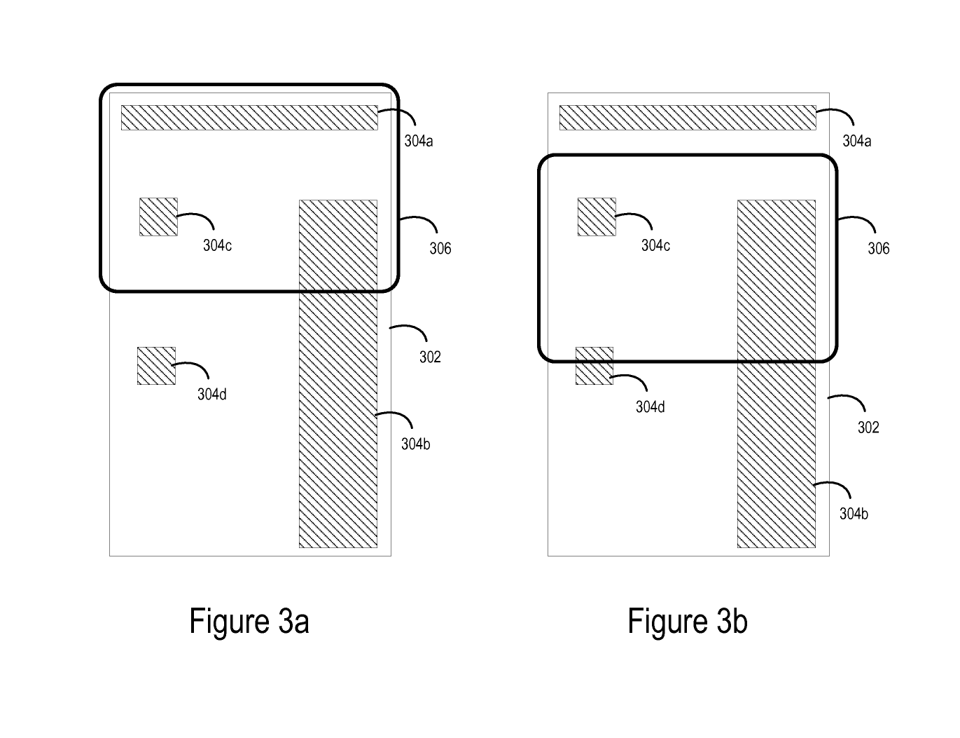

FIGS. 3a and 3b illustrate examples of viewable and non-viewable impressions. FIGS. 3a and 3b each illustrate an online property 302 (e.g., a web page). FIGS. 3a and 3b each illustrate a respective visible area of the property 302 within boundaries of a display area 306 of a browser. Ad impressions 304a-304d are included in the property at a given time period in FIGS. 3a and 3b. In FIG. 3a, the display area 306 is at the top of the property 302. In FIG. 3b, the display area 306 is at a lower part of the property 306. As illustrated, the impressions 304a-304d are at the same locations on the property 302 during the given time period; however, the display area 306 exposes different impressions in FIGS. 3a and 3b. For example, in FIG. 3a, impressions 304a-304c are exposed (i.e., viewable impressions). Whereas, impression 304d is not a viewable impression. In FIG. 3b, the viewable impressions include impressions 304b-304d. In both Figures, impression 304c is completely viewable and impression 304b is partially viewable. As illustrated, an impression can be completely viewable or partially viewable to a degree. For example, in FIG. 3a, impression 304b is approximately 25% viewable, and in FIG. 3b, impression 304b is approximately 50% viewable. Forecasts of viewable impressions based on historical viewable impressions may also be based on the degrees that the impressions were viewable. For example, forecasts may be based on impressions that were at least 50% viewable.

FIG. 4 illustrates a block diagram of example aspects of a system, such as the system in FIG. 1, which can manage viewable impressions (such as managing viewable impressions by providing guaranteed viewable impressions through a legacy impression-based channel). Each of the circuitries may be hosted by one or more servers, such as one or more of the servers illustrated in FIG. 1. For example, many of the circuitries may be embedded in the viewable impressions server 116. The circuitries in FIG. 4 include forecasting circuitry 402, distribution circuitry 404, booking circuitry 406, probability circuitry 408, viewable impressions prediction circuitry 410, scoring circuitry 412, impression rate circuitry 414, arbitrage circuitry 416, log circuitry 418, interface circuitry 420, client-side application circuitry 422, marketing channel circuitries 424a-424c. Each of the circuitries can be communicatively coupled with each other. For example, the circuitries 402-420 may be communicatively coupled via a bus 426. Also, these circuitries and the bus may be part of the viewable impressions server 116, for example. Also, these circuitries may be communicatively coupled with other circuitries and/or themselves over a network, such as network 120 illustrated in FIG. 1. For example, circuitries of the viewable impressions server 116 may be communicatively coupled to the client-side application circuitry 422 and the marketing channel circuitries 424a-424c over the network 120. The client-side application circuitry 422 may be a part of any one of the client devices 122-128 illustrated in FIG. 1. The marketing channel circuitries 424a-424c each may be part of any one or more of the servers illustrated in FIG. 1. Additionally or alternatively, the circuitries 402-420 may be part of any one or more of the servers illustrated in FIG. 1.

The client-side application circuitry 422 may include or be configured to load and render a client-side aspect of a correlator configured to identify a viewable impression (such as a complete view tracking mechanism associated with a multimedia player rendered through a web browser and/or webpage). The viewable impressions server 116 may serve the client-side aspect of the correlator to the client-side application circuitry 422. Also, the viewable impressions server 116 may include a corresponding server-side aspect of the correlator. The correlator may be switched off to conserve client-side, server-side, and network resources, such as memory, data processing resources, data transport resources, and network bandwidth. In an example, it may be advantageous to use the correlator initially for a pre-defined number of initial campaigns and/or a pre-defined initial time period of a campaign.

FIG. 4 illustrates the viewable impressions server 116 receiving session data 401 via its interface circuitry 420. The interface circuitry 420 may include or be associated with a correlator configured to identify viewable impressions. The session data 401 may be communicated from the client-side application circuitry 422, such as via a client-side aspect of a correlator. In an example, the session data 401 may include corresponding device data, user profile data, user interaction data, and application specific session data associated with the client-side application run by the client-side application circuitry 422. The session data 401 may be received by the interface circuitry 420 directly from the client-side application circuitry over the network 120 or from user interaction logs stored on servers on the network, such as the analytics server 118.

The interface circuitry 420 may also output viewable impressions data 403, which may be communicated to the viewable impressions database 117 or over the network 120 and to servers hosting the marketing channels, such as channels 424a-424c. Also, through the network 120, such as by the ad server 108, ad data 405 along with the viewable impressions data 403 may be communicated to the marketing channels and back to the client-side application circuitry 422.

The client-side application circuitry 422 may use the ad data 405 to render corresponding viewable impressions. The marking channels may use the viewable impressions data 403 to direct the use of the ad data 405 by the client-side application circuitry 422. For example, at a server of marketing channel, a circuitry of channel may filter the ad data 405 according to the viewable impression data 403. This filtered ad data may then be used to render impressions accordingly.

Further, analytics, user interaction data, ad targeting and/or retargeting data, ad data, or any combination thereof may be communicated back to the viewable impressions server 116 via the interface circuitry 420, such as in the form of feedback data 407. The feedback data 407 may enhance the determinations of the viewable impressions data 403. Also, as depicted in FIG. 4, each circuitry of the viewable impressions server 116 can provide input and feedback to the other circuitries of the viewable impressions server, and to other parts of the system such as any one or more of the servers illustrated in FIG. 1. The viewable impressions data 403 may include data corresponding to output of any one of the circuitries of the viewable impressions server 116 (such as respective outputs of the circuitries 402-408).

In an example, a webpage can provide a search tool, a content stream (such as where selecting an item in the stream results in an online presentation of corresponding content), and other sources of online generated revenue, such as advertisements served through guaranteed display advertising (GDA) channels. For examples of such items, see FIG. 2 and the corresponding description. In FIG. 4, the marketing channels 424a-424b may each include one or more of these technologies and sources of revenue. In such examples, tracking of viewable impressions may be incorporated with the webpage or a collection of related webpages including the aforementioned elements. In another example, the content provider providing content listed in the depicted webpage also can provide the search engine services and the marketing channel services from any parts of the system illustrated in FIGS. 1 and 4. Additionally or alternatively, the system of these Figures may exchange information with other information systems, such as other systems providing one or more of content, advertising services, and online searching technologies. These other systems may include cloud computing systems and social media systems (such as an online social networking service). Also, in these examples, tracking of viewable impressions may be incorporated.

The viewable impressions server 116 includes the interface circuitry 420, which can be configured to receive session data 401, such as browser and user session data associated with a web browser session. The session data 401 can include information regarding tracked viewable impressions. The viewable impressions server 116 can also include log circuitry 418 that can be configured to generate user interaction logs (including logs of viewable impressions) according to the session data 401. The log circuitry 418 may include a server-side aspect of a correlator, and the interface circuitry 420 may bridge the client-side and server-side aspect of the correlator. Additionally or alternatively, the session data 401 can be provided by any one or more of the servers illustrated in FIG. 1, such as the analytics server 118, the content server 112, and the ad server 108. In such examples, the viewable impression information may be provided directly from such servers in that the information bypassing further processing by the log circuitry 418.

The forecasting circuitry 402 can be configured to forecast a viewable impression rate for an ad spot on an online property, such as a webpage. The forecasting circuitry 402 can include probability circuitry 408 configured to determine a probability that an online ad at a location on a page will be visible for a user on the page. The probability can be determined according to a page parameter of the page, an ad spot parameter of the location on the page, a user parameter of the user, and an inventory parameter of a supply of impressions of an online ad campaign. The page parameter, the ad spot parameter, and the user parameter can be identified by the forecasting circuitry 402 in the generated user interaction logs (e.g., the logs generated by the log circuitry 418), logs of the analytics server 118, and/or or preprocessed logs of the session data 401. The forecasting circuitry 402 can also include viewable impressions prediction circuitry 410 configured to predict an amount of viewable impressions to occur within a time period of the campaign according to the probability, resulting in a forecast. The forecasting circuitry 402 can also include scoring circuitry 412 configured to determine a score according to the forecast, for at least the user. The score can indicate a fraction of impressions at the location that will most likely be visible to at least the user. The forecasting circuitry 402 can be further configured to determine the probability at the circuitry 408, predict the amount of viewable impressions at the circuitry 410, and determine the score at the circuitry 412 at commencement of the time period of the campaign.

The page parameter can include subject matter of a page, graphical features of the page, dimensions of the page, viewable portions of the page, visibility rates of the portions or the whole page, rate of impressions on the page, and temporal information regarding any one or more of the aforementioned parameters. The ad spot parameter can include subject matter of an ad spot, dimensions of the spot, viewable portions of the spot, visibility rates of the portions or the whole spot, rate of impressions on the spot, and temporal information regarding any one or more of the aforementioned parameters. The user parameter can include a demographic of the user (e.g., age, sex, residence, and birthplace), a psychographic of the user (e.g., online behavior such as average dwell time, common online queries, and rates of certain queries), a geographic location of the user, and temporal information regarding any one or more of the aforementioned parameters or any combination thereof. The inventory parameter includes a supply forecast that is indicative of a forecasted amount of impressions available for the campaign and temporal information regarding the aforementioned parameter. In an example, at least some of these parameters are determined according to data communicated from a server of an impression-based guaranteed display advertising environment, such as an environment including the marketing channel 424b.

Also, the forecasting circuitry 402 can be configured to repeat the determination of the probability at the circuitry 408 and the prediction of the amount of viewable impressions at the circuitry 410 for another user. In an example, the forecasting circuitry 402 can then determine the score according to the forecasts for at least the first and second users, wherein the score indicates a fraction of impressions at the location that will most likely be visible to at least the first and second users. The score can be used as an indication of a fraction of impressions at the location that will most likely be visible to all users that navigate to the online property. In other words, the score indicates a fraction of impressions at the location that will most likely be visible to all users of the page.

The distribution circuitry 404 can be configured to control an impression rate of the campaign according to the score. The distribution circuitry 404 can also be configured to distribute impressions of the supply of impressions according to the impression rate.

The distribution circuitry 404 can also be further configured to control an impression rate of a second campaign according to the score. In such an example, the distribution circuitry 404 can distribute impressions of a supply of impressions of the second campaign according to the impression rate of the second campaign. Also, in such an example, the distribution circuitry can determine whether the second campaign is relatively comparable to the first campaign by determining a likeness score and comparing the likeness score to a likeness threshold. The campaigns are relatively comparable when the likeness score for the campaigns exceeds the likeness threshold. If the threshold is exceeded, then the distribution circuitry 404 can control the impression rate of the second campaign according to the score initially determined for the first campaign. Alternatively, where the threshold is exceeded, the circuitry can distribute the impression of the second campaign according to the impression rate of the first campaign (such as without determining an impression rate for the second campaign).

The booking circuitry 406 can be configured to price an impression of the campaign according to the score. The booking circuitry 406 can also price an impression of another campaign according to the score. In such an example, the booking circuitry can determine whether the second campaign is relatively comparable to the first campaign by determining a likeness score. Where the likeness score for the campaigns exceeds a likeness threshold, the campaigns are identified to be relatively comparable. Therefore, if the threshold is exceeded, then booking circuitry 406 can price impressions of the second campaign according to the score initially determined for the first campaign.

Additionally, the forecasting circuitry 402 can be configured to repeat the determination of the probability at circuitry 408, the prediction of the amount of viewable impressions for the user at circuitry 410, and the determination of the score at circuitry 412 at commencement of a second time period of the campaign according to feedback from the first time period, resulting in an updated score. In such an example, the feedback includes an amount of impressions of the campaign visible during the first time period. Also, in such an example, the distribution circuitry 404 can be further configured to control the impression rate of the campaign according to the updated score. Also, the booking circuitry 406 can be configured to price an impression of the campaign according to the updated score.

Additionally, the forecasting circuitry 402 can be configured to repeat the determination of the probability at circuitry 408, the prediction of the amount of viewable impressions for the user at circuitry 410, and the determination of the score at circuitry 412 relative to a second campaign instead of the first campaign and according to feedback from the first time period of the first campaign, the second time period of the first campaign, or both time periods of the first campaign. These repeats of the operations of the forecasting circuitry can result in a shared score that can be used by the distribution circuitry 404 to control respective impression rates of the first and second campaigns according to the shared score. Further, in such an example, the distribution circuitry 404 can include the arbitrage circuitry 416 that can be configured to perform an arbitrage between the first and second campaigns based on the respective impression rates and/or the shared score.

Additionally, averages of scores for different time periods and/or campaigns can be used to determine pricing and/or control of distribution of viewable impressions and/or regular impressions. FIG. 5 illustrates example operations 500 performed by a system, such as one of the systems illustrated in FIGS. 1 and 4. The example operations 500 include averaging of the scores for different time periods and/or campaigns to determine pricing and/or control of distribution of impressions. For example, a system such as the system of the viewable impression server 116 can include circuitry (such as the interface circuitry 420) that can receive session data (such as session data 401) at 502. From the session data, a user interaction log can be generated at circuitry (such as the log circuitry 418) at 504. The viewable impression server 116 can also include circuitry (such as the probability circuitry 408) to determine a probability that an online ad at a location on a page will be viewable and/or completely viewed on the page at 506. For example, at 506, the circuitry can determine a probability that a video ad on a page is completely played on the page. The probability determination at 506 can be based on at least the user interaction log and/or the session data. The log and/or the session data can indicate a page parameter of the page, an ad spot parameter of the location on the page, a user parameter of the user, and an inventory parameter of a supply of impressions of a first online ad campaign.

At 508, circuitry (such as the prediction circuitry 410) can be configured to predict an amount of viewable impressions to occur within a time period of the first campaign according to the probability determined at 506, which results in a forecast. Circuitry (such as the scoring circuitry 412) can also be configured to determine a first score according to the forecast, for at least the user at 510. The first score can indicate a fraction of impressions at the location that will most likely be visible to at least the user.

Initially, the determination of the score can be coordinated, at least in part, by a correlator. However, in an example, it may be advantageous to turn off the correlator and rely exclusively on historical information as the campaign progresses. Also, it may be advantageous, to only use a correlator with a pre-defined initial group of campaigns, and subsequent campaigns may only use historical data including viewable impression data collected from the initial group of campaigns. Such a technique may dramatically reduce the use of client-side, server-side, and network resources. Such resources conserved, may include memory resources, data processing resources, and network bandwidth resources. The use of a correlator may be taxing on these three types of resources.

In an example, for a pre-defined initial period of time, in general or for a campaign, operations may include identifying in real-time, by a correlator, an ad spot parameter and a page parameter of a corresponding page. The the operations may continue with deactivating the correlator immediately subsequent to the identifying of the ad spot parameter and the page parameter, if the initial period of time has ended. Then the operations of the forecasting circuitry can commence relying only on historical data and real-time data identified from the brief use of the correlator. In other words, the correlator may be used for an initial learning phase only, to conserve resources. The pre-defined initial period may be adjusted according to preferences of the advertiser or the ad system administrator. With a longer initial period, the score should become more accurate and stable. However, the tradeoff of using the correlator for a longer period is a greater use of resources, which can be costly as scope of the ad network increases.

The circuitry can also be configured to repeat the determination of the probability at 506, the prediction of the amount of viewable impressions at 508, and the determination of the first score at 510 relative to a second online ad campaign instead of the first campaign. This last operation results in a second score. This repeat can occur for the second online campaign, if another campaign exists that includes a request for distribution based on viewable impression. See the determination at 512. With at least the first and second scores, the circuitry can average such scores resulting in an averaged score at 514. Then according to the averaged score, the circuitry can be configured to price and/or control distribution of respective impressions of at least the first and second campaigns according to the averaged score at 516. For example, the circuitry can be configured to control respective impression rates of the first and second campaigns according to the averaged score. Also, with respect to this last operation, besides using the correlator with respect to an initial time period, the correlator may be used with respect to a pre-defined number of initial campaigns. Then the correlator can be turned off for latter campaigns to conserve resources.

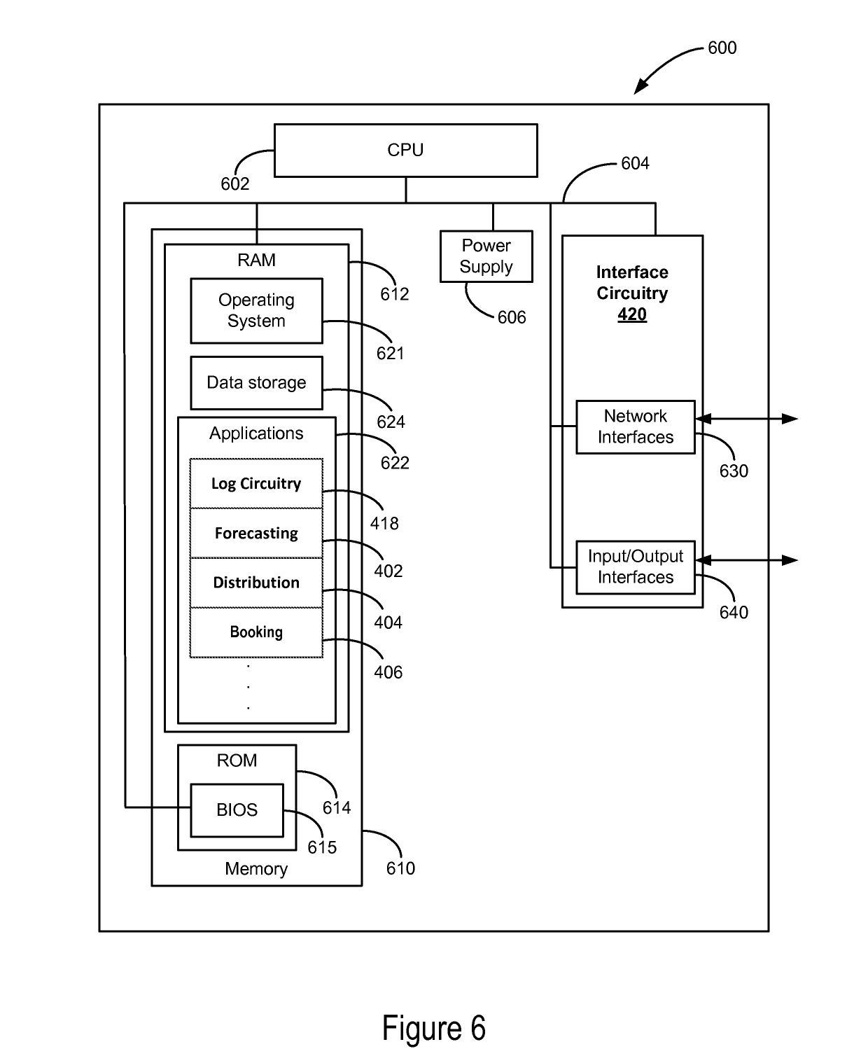

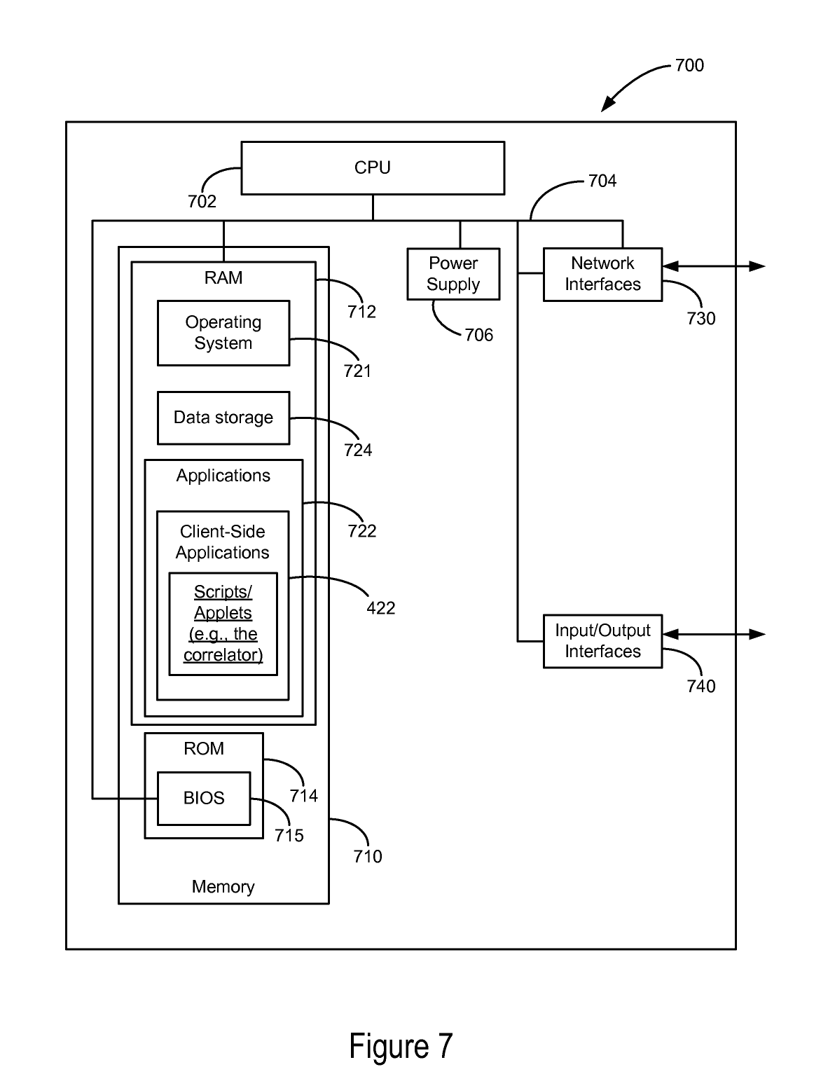

FIGS. 6 and 7 are block diagrams of example electronic devices that can implement aspects of and related to example systems that can manage viewable impressions. FIG. 6 illustrates a server, such as the viewable impressions server 116. FIG. 7 illustrates a client device, such as any one of the client devices 122-128 illustrated in FIG. 1 or a device that hosts the client-side application circuitry 422 illustrated in FIG. 4.

The electronic device 600 can include a CPU 602, memory 610, a power supply 606, and input/output components, such as network interfaces 630 and input/output interfaces 640, and a communication bus 604 that connects the aforementioned elements of the electronic device. The network interfaces 630 can include a receiver and a transmitter (or a transceiver), and an antenna for wireless communications. The network interfaces 630 can also include at least part of the interface circuitry 420 illustrated in FIG. 4. The CPU 602 can be any type of data processing device, such as a central processing unit (CPU). Also, for example, the CPU 602 can be central processing logic.

The memory 610, which can include random access memory (RAM) 612 or read-only memory (ROM) 614, can be enabled by memory devices. The RAM 612 can store data and instructions defining an operating system 621, data storage 624, and applications 622, such as applications implemented through hardware including the search history circuitry 302, the ad interaction history circuitry 304, the matcher 306, and the log circuitry 418, the forecasting circuitry 402, the distribution circuitry 404, and the booking circuitry 406. The applications 622 may include hardware (such as circuitry and/or microprocessors), firmware, software, or any combination thereof. The ROM 614 can include basic input/output system (BIOS) 615 of the electronic device 600. The memory 610 may include a non-transitory medium executable by the CPU.

The power supply 606 contains power components, and facilitates supply and management of power to the electronic device 600. The input/output components can include at least part of the interface circuitry 420 for facilitating communication between any components of the electronic device 600, components of external devices (such as components of other devices of the information system 100), and end users. For example, such components can include a network card that is an integration of a receiver, a transmitter, and I/O interfaces, such as input/output interfaces 640. The I/O components, such as I/O interfaces 640, can include user interfaces such as monitors, keyboards, touchscreens, microphones, and speakers. Further, some of the I/O components, such as I/O interfaces 640, and the bus 604 can facilitate communication between components of the electronic device 600, and can ease processing performed by the CPU 602.

The electronic device 600 can send and receive signals, such as via a wired or wireless network, or may be capable of processing or storing signals, such as in memory as physical memory states, and may, therefore, operate as a server. The device 600 can include a single server, dedicated rack-mounted servers, desktop computers, laptop computers, set top boxes, integrated devices combining various features, such as two or more features of the foregoing devices, or the like.

The electronic device 700 can include a central processing unit (CPU) 702, memory 710, a power supply 706, and input/output components, such as network interfaces 730 and input/output interfaces 740, and a communication bus 704 that connects the aforementioned elements of the electronic device. The network interfaces 730 can include a receiver and a transmitter (or a transceiver), and an antenna for wireless communications. The CPU 702 can be any type of data processing device, such as a central processing unit (CPU). Also, for example, the CPU 702 can be central processing logic; central processing logic may include hardware (such as circuitry and/or microprocessors), firmware, software and/or combinations of each to perform functions or actions, and/or to cause a function or action from another component. Also, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software.

The memory 710, which can include random access memory (RAM) 712 or read-only memory (ROM) 714, can be enabled by memory devices, such as a primary (directly accessible by the CPU) and/or a secondary (indirectly accessible by the CPU) storage device (such as flash memory, magnetic disk, optical disk). The memory 710 may include a non-transitory medium executable by the CPU.

The RAM 712 can store data and instructions defining an operating system 721, data storage 724, and applications 722, including the client-side application circuitry 422 illustrated FIG. 4. The applications 722 may include hardware (such as circuitry and/or microprocessors), firmware, software, or any combination thereof. Example content provided by an application, such as the client-side application circuitry 422, may include text, images, audio, video, or the like, which may be processed in the form of physical signals, such as electrical signals, for example, or may be stored in memory, as physical states, for example. The scripts/applets illustrated in the client-side applications 722 may include a correlator configured to perform various tasks associated with identifying and tracking viewable impressions.

The ROM 714 can include basic input/output system (BIOS) 715 of the electronic device 700. The power supply 706 contains power components, and facilitates supply and management of power to the electronic device 700. The input/output components can include various types of interfaces for facilitating communication between components of the electronic device 700, components of external devices (such as components of other devices of the information system 100), and end users. For example, such components can include a network card that is an integration of a receiver, a transmitter, and I/O interfaces, such as input/output interfaces 740. A network card, for example, can facilitate wired or wireless communication with other devices of a network. In cases of wireless communication, an antenna can facilitate such communication. The I/O components, such as I/O interfaces 740, can include user interfaces such as monitors, keyboards, touchscreens, microphones, and speakers. Further, some of the I/O components, such as I/O interfaces 740, and the bus 704 can facilitate communication between components of the electronic device 700, and can ease processing performed by the CPU 702.

1. A system for providing viewable impressions, comprising:
forecasting circuitry configured to:
determine a probability that an online ad at a location on a page will be visible for a user on the page, based on a page parameter of the page, an ad spot parameter of the location on the page, a user parameter of the user, and an inventory parameter of a supply of impressions of an online ad campaign;
predict an amount of viewable impressions to occur within a time period of the campaign according to the probability, resulting in a forecast; and
determine a score according to the forecast, for at least the user, the score indicating a fraction of impressions at the location that will most likely be visible to at least the user; and
distribution circuitry configured to:
control an impression rate of the campaign according to the score; and
distribute impressions of the supply of impressions according to the impression rate.

2. The system of claim 1, wherein the forecasting circuitry is further configured to determine the probability, predict the amount of viewable impressions, and determine the score at commencement of the time period.

3. The system of claim 1, wherein the user parameter includes a demographic of the user, a psychographic of the user, a geographic location of the user, or any combination thereof.

4. The system of claim 1, wherein the inventory parameter includes a supply forecast that is indicative of a forecasted amount of impressions available for the campaign.

5. The system of claim 1, wherein at least some of the parameters are determined according to data communicated from a server of an impression-based guaranteed display advertising environment.

6. The system of claim 1, wherein the user is a first user and wherein the forecasting circuitry is further configured to:
repeat the determination of the probability and the prediction of the amount of viewable impressions for a second user; and
determine the score according to the forecasts for at least the first and second users, wherein the score indicates a fraction of impressions at the location that will most likely be visible to at least the first and second users.

7. The system of claim 6, wherein the score indicates a fraction of impressions at the location that will most likely be visible to all users of the page.

8. The system of claim 1, wherein the campaign is a first campaign, and wherein the distribution circuitry is further configured to:
control an impression rate of a second campaign according to the score; and
distribute impressions of a supply of impressions of the second campaign according to the impression rate of the second campaign.

9. The system of claim 8, wherein the second campaign is relatively comparable to the first campaign in that a likeness score for the campaigns exceeds a likeness threshold.

10. The system of claim 1, further comprising booking circuitry configured to price an impression of the campaign according to the score.

11. The system of claim 10, wherein the campaign is a first campaign, and wherein the booking circuitry is further configured to price an impression of a second campaign according to the score.

12. The system of claim 11, wherein the second campaign is relatively comparable to the first campaign in that a likeness score for the campaigns exceeds a likeness threshold.

13. The system of claim 1, wherein the time period is a first time period, and wherein the forecasting circuitry is further configured to:
repeat the determination of the probability, the prediction of the amount of viewable impressions for the user, and the determination of the score at commencement of a second time period of the campaign according to feedback from the first time period, resulting in an updated score.

14. The system of claim 13, wherein the feedback includes an amount of impressions of the campaign visible during the first time period.

15. The system of claim 13, wherein the distribution circuitry is further configured to control the impression rate of the campaign according to the updated score.

16. The system of claim 15, further comprising booking circuitry configured to price an impression of the campaign according to the updated score.

17. The system of claim 13, wherein the campaign is a first campaign and wherein the forecasting circuitry is further configured to:
repeat the determination of the probability, the prediction of the amount of viewable impressions for the user, and the determination of the score relative to a second campaign instead of the first campaign and according to feedback from the first time period of the first campaign, the second time period of the first campaign, or both time periods of the first campaign.

18. The system of claim 17, wherein the repeats of operations of the forecasting circuitry result in a shared score, and wherein the distribution circuitry is further configured to:
control respective impression rates of the first and second campaigns according to the shared score; and
perform an arbitrage between the first and second campaigns based on the respective impression rates.

19. A method, comprising:
identifying, by a correlator, an ad spot parameter and a page parameter of a corresponding page;
deactivating the correlator, immediately subsequent to the identifying of the ad spot parameter and the page parameter;
determining, by forecasting circuitry, a probability that an online ad at a location on a page will be visible for a user on the page, based on the page parameter of the page, the ad spot parameter, which is associated with the location on the page, a user parameter of the user, and an inventory parameter of a supply of impressions of a corresponding online ad campaign;
predicting, by the forecasting circuitry, an amount of viewable impressions to occur within a time period of the campaign according to the probability, resulting in a forecast;
determining, by the forecasting circuitry, a score according to the forecast, for at least the user, the score indicating a fraction of impressions at the location that will most likely be visible to at least the user; and
controlling, by distribution circuitry, an impression rate of the campaign according to the score.

20. A system, comprising a non-transitory medium including instructions, which when executed by a processor, are configured to:
determine a probability that an online ad at a location on a page will be visible for a user on the page, based on a page parameter of the page, an ad spot parameter of the location on the page, a user parameter of the user, and an inventory parameter of a supply of impressions of a first online ad campaign;
predict an amount of viewable impressions to occur within a time period of the first campaign according to the probability, resulting in a forecast;
determine a first score according to the forecast, for at least the user, the first score indicating a fraction of impressions at the location that will most likely be visible to at least the user;
repeat the prediction of the amount of viewable impressions for the user, and the determination of the first score, relative to a second online ad campaign instead of the first campaign, resulting in a second score;
average the first and second scores, resulting in an averaged score; and
price respective impressions of the first and second campaigns according to the averaged score.
